(19) United States
(12) Patent Application Publication
(10) Pub. No.: US 2019/0030435 A1
(43) Pub. Date: Jan. 31, 2019

(54) SYSTEM AND METHOD FOR MANAGING PREDICTIONS OF OUTCOMES IN LIVE EVENTS IN REAL TIME

(71) Applicant: Tyler Dishman, Greenwood, IN (US)

(72) Inventor: Tyler Dishman, Greenwood, IN (US)

(21) Appl. No.: 16/020,480

(22) Filed: Jun. 27, 2018

Related U.S. Application Data
(60) Provisional application No. 62/539,172, filed on Jul. 31, 2017.

(51) Int. Cl. A63F 13/65; A63F 13/812; A63F 13/46; A63F 13/77

(52) U.S. Cl. CPC A63F 13/65; A63F 13/77; A63F 13/46; A63F 13/812

(57) ABSTRACT

System and methods for managing predictions of outcomes in live events in real time on a computing platform are disclosed herein. The system allows users to predict outcomes of sub-events, such as plays, in real time during a live event, such as a football game, based on and in response to actual actions occurring in the live event. The user may view the live event in-person, on television, or through the Internet. The system is meant to reward those users having more knowledge and skill regarding a particular live event.

### PRIORITY CLAIM

This patent application claims priority to and the benefit of the filing date of provisional patent application U.S. Ser. No. 62/539,172 filed on Jul. 31, 2017, which is incorporated herein in its entirety.

### FIELD

This patent application relates to a game for managing predictions of outcomes in live events in real time on a computing platform.

### BACKGROUND

Fantasy gaming continues to grow in popularity worldwide, particularly for sports, such as American football, basketball, hockey, and baseball. Participants of a fantasy game can predict outcomes of individual sporting events or they can predict which athletes that are competing in the real sporting events will statistically perform the best in one game, match, show, etc. or in the course of an entire season. The athletes' real-world statistics are often compared with the statistics of other athletes. Typically, a fantasy game participant will select a team made up of real athletes and then wait to see how well the real athletes or team statistically performs. Thus, the fantasy game participant makes the prediction(s) prior to the start of a live game, match, or show and then passively watches the live game, match, or show to determine the accuracy of his predictions, without having the ability to change or modify his predictions during the live game, match, or show.

There are numerous factors in the live game, match, or show, such as injuries to the athletes, weather conditions, and matchups against other real opponents, that commonly affect the outcome of the live game, match, or show and the performance of the respective athletes. Without the ability to change or modify the initial predictions made by the fantasy game participant in response to these factors, luck becomes a more prevalent component to the fantasy game. As a result, less knowledgeable and less skillful fantasy game participants may be rewarded over those having more knowledge and skill about a particular real game, match, or show. The more knowledgeable and skillful fantasy game participants are more likely to accurately predict the outcomes of events in response to conditions of the live game, match, or show.

Further, when people watch live games, matches, or shows on television, particularly sporting events, they often become very immersed and invested in the live games, matches, and shows. People continue looking for ways to become involved with or a part of these live games, matches, or shows. As video games and fantasy games become more prevalent and technologically advanced, people continue trying to find ways to immerse themselves in the live games. In the context of sporting events, this may involve pretending to manage or coach a real team or player. As a result, there is a need for a system and method that allows participants to predict outcomes of events/sub-events in real time based on actions that have previously occurred or are currently occurring in a live event.

### SUMMARY

What is provided are systems and methods for managing predictions of outcomes in live events in real time on a computing platform. In some examples, the system allows users to predict outcomes of sub-events, such as plays, in real time during a live event, such as a football game, based on and in response to actual actions occurring in the live event. The user may view the live event in-person, on television, or through the Internet. Thus, the system provides a “game within a game” for a live event by allowing users to predict outcomes of sub-events occurring during the live event on a real-time basis. As a result, the system is meant to reward those users having more knowledge and skill regarding a particular live event.

In an exemplary embodiment, the system disclosed herein includes a user application configured to be distributed to one or more user computing devices, the user application configured to receive one or more selections of live events and one or more predictions for outcomes of sub-events from the user computing device, the live event is broadcast to the users on a secondary device in real time; a spotter computing system, the spotter computing system having a spotter system database configured to store data and information corresponding to sequential sub-events occurring during the live event; the spotter computing system further comprising a spotter system processor in communication with the spotter system database, the spotter system processor configured to capture and process the data and information corresponding to sequential sub-events occurring during the live event; the spotter computing system further configured to synchronize the user computing device with the secondary device based on the sequential sub-events occurring during the live event; identify a latency period between the secondary device and a live event feed obtained from the live event; and mark each of the sub-events from the live event with a timestamp and record the latency-adjusted timestamp associated with the predictions on the user computing device.

In an exemplary embodiments, the system further comprises a game logic computing system, the game logic computing system having a game logic database configured to store data and information corresponding to the predictions made by users for outcomes of sub-events associated with the live event and the latency-adjusted timestamps associated with the predictions; the game logic computing system further comprising a game logic processor in communication with the game logic database, the game logic processor configured to process the data and information corresponding to predictions made by users for outcomes of sub-events associated with the live event and the latency-adjusted timestamps associated with the predictions; and the game logic computing system further configured to assign points associated with the plurality of possible outcomes for each of the sub-events; determine outcomes for the predictions based on the data associated with the sub-event and the latency-adjusted timestamps associated with the predictions; and dynamically award points to the user during the live event based upon determining that the predictions from the user computing device were received by the game logic computing system before the sub-event occurred in the live event and before the sub-event was displayed on the secondary device.

In an exemplary embodiment, the method for managing predictions of outcomes in live events comprises generating a list of live events for display on a graphical user interface of a user computing device; receiving a selection of a live event from the list of live events from the user computing device, the selection of the live event is associated with a user; receiving a captured audio and/or video segment of the live event from the user computing device, the live event is broadcast to the user on a secondary device in real time; and capturing and processing, via a computing system, data associated with a live event feed, the live event feed has content associated with a plurality of sub-events from the broadcast live event, the content from the live event feed is captured by the computing system prior to the sub-events being displayed on the secondary device, the live event feed further comprises a plurality of timestamped video frames displaying the content associated with the sub-events; and a data feed, the data feed describes the sub-events in the timestamped video frames.

The method for managing predictions of outcomes for live events further comprises synchronizing the user computing device with the secondary device based on information corresponding to the broadcast live event and the live event feed to identify a latency period between the secondary device and the live event feed; marking, via the computing system, each of the sub-events from the live event feed with a timestamp at the start of each of the sub-events, assigning points, via the computing system, associated with a plurality of possible outcomes for each of the sub-events; storing, on a database of the computing system, data associated with the sequential sub-events for the broadcast live event including the timestamp for each of the sub-events and the points assigned for the possible outcomes for each of the sub-events; receiving, via the computing system, at least one prediction from the user computing device for the outcome of one of the sub-events associated with the broadcast live event, the at least one prediction is received by the computing system prior to the sub-event being displayed on the secondary device; and determining at least one outcome of the at least one prediction based on the data associated with the sub-event and the time in which the computing system received the at least one prediction.

In an exemplary embodiment, the method for awarding points to a user based on the accuracy and timeliness of the user's prediction during the live event comprises storing each prediction made by the user; identifying, via the game logic computing system, whether or not an outcome may be calculated and points may be awarded; storing information on the game logic computing system relating to whether points should be awarded to user for sub-event prediction; notifying the user computer device of the results for the user's prediction; and calculating the total points awarded to each user and ranking each user participating in the live event.

### BRIEF DESCRIPTION OF THE DRAWINGS

Subject matter is particularly pointed out and distinctly claimed in the concluding portion of the specification. Claimed subject matter, however, as to structure, organization and method of operation, together with objects, features, and advantages thereof, may best be understood by reference to the following detailed description if read with the accompanying drawings in which:

FIG. 1 is a system diagram of an example gaming system for predicting outcomes of sub-events in real time;

FIG. 2 is a flow chart of an example method for receiving and processing a prediction during a live event using the gaming system of FIG. 1;

FIG. 3 is a flow chart of an example method for awarding points to a user during a live event using the gaming system of FIG. 1;

FIG. 4 is a graphical user interface drawing of an example GUI for making a predicting of an outcome for a sub-event through the gaming system of FIG. 1;

FIG. 5 is a graphical user interface drawing of an example GUI for displaying the outcome of the user's prediction through the gaming system of FIG. 1; and

FIG. 6 is a graphical user interface drawing of an example GUI for making predictions for the type of play and result of the play through the gaming system of FIG. 1.

### DETAILED DESCRIPTION

In the following detailed description, numerous specific details are set forth in order to provide a thorough understanding of the examples as defined in the claimed subject matter, and as an example of how to make and use the examples described herein. However, it will be understood by those skilled in the art that claimed subject matter is not intended to be limited to such specific details, and may even be practiced without requiring such specific details. In other instances, well-known methods, procedures, and ingredients have not been described in detail so as not to obscure the invention defined by the claimed subject matter.

Some portions of the detailed description that follow are presented in terms of algorithms and/or symbolic representations of operations on data bits and/or binary digital signals stored within a computing system, such as within a computer and/or computing system memory. An algorithm is here and generally considered to be a self-consistent sequence of operations and/or similar processing leading to a desired result. The operations and/or processing may take the form of electrical and/or magnetic signals configured to be stored, transferred, combined, compared and/or otherwise manipulated. It has proven convenient at times, principally for reasons of common usage, to refer to these signals as bits, data, values, elements, symbols, characters, terms, numbers, numerals and/or the like. It should be understood, however, that all of these and similar terms are to be associated with appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device that manipulates and/or transforms data represented as physical electronic and/or magnetic quantities and/or other physical quantities within the computing platform's processors, memories, registers, and/or other information storage, transmission, and/or display devices. Though these descriptions are commonly used in the art and are provided to allow one of ordinary skill in this field to understand the examples provided herein, this application does not intend to claim subject matter outside of the scope of 35 U.S.C. 101, and claims and claim terms herein should be interpreted to have meanings in compliance with this statute's requirements.

Unless specifically stated otherwise, as apparent from the following discussion, it is appreciated that throughout this specification a computing platform includes, but is not limited to, a device such as a computer or a similar electronic computing device that manipulates and/or transforms data represented by physical, electronic, and/or magnetic quantities and/or other physical quantities within the computing platform's processors, memories, registers, and/or other information storage, transmission, reception and/or display devices. Accordingly, a computing platform refers to a system, a device, and/or a logical construct that includes the ability to process and/or store data in the form of signals. Thus, a computing platform, in this context, may comprise hardware, software, firmware and/or any combination thereof. Where it is described that a user instructs a computing platform to perform a certain action, it is understood that “instructs” may mean to direct or cause to perform a task as a result of a selection or action by a user. A user may, for example, instruct a computing platform embark upon a course of action via an indication of a selection, including, for example, pushing a key, clicking a mouse, maneuvering a pointer, touching a touch pad, touching a touch screen, acting out touch screen gesturing movements, maneuvering an electronic pen device over a screen, verbalizing voice commands, and/or by audible sounds. A user may include an end-user.

Flowcharts, also referred to as flow diagrams by some, are used in some figures herein to illustrate certain aspects of some examples. Logic they illustrate is not intended to be exhaustive of any, all, or even most possibilities. Their purpose is to help facilitate an understanding of this disclosure with regard to the particular matters disclosed herein. To this end, many well-known techniques and design choices are not repeated herein so as not to obscure the teachings of this disclosure.

Throughout this specification, the term “system” may, depending at least in part upon the particular context, be understood to include any method, process, apparatus, and/or other patentable subject matter that implements the subject matter disclosed herein. The subject matter described herein may be implemented in software, in combination with hardware and/or firmware. For example, the subject matter described herein may be implemented in software executed by a hardware processor.

As used herein, the term “real time” is intended to broadly refer to a condition/live event that is generated and communicated substantially contemporaneously with minimal delay. As an example, a delay of less than several seconds, or less than 1 second, between and live event and a broadcast of the live event to another device may be considered live for purposes of the invention disclosed herein. It will therefore be appreciated that the terms “live” or “real time” when used in this context are not limited to zero delay, but instead indicate that some minimal delay is allowed, which may be, for example, several seconds.

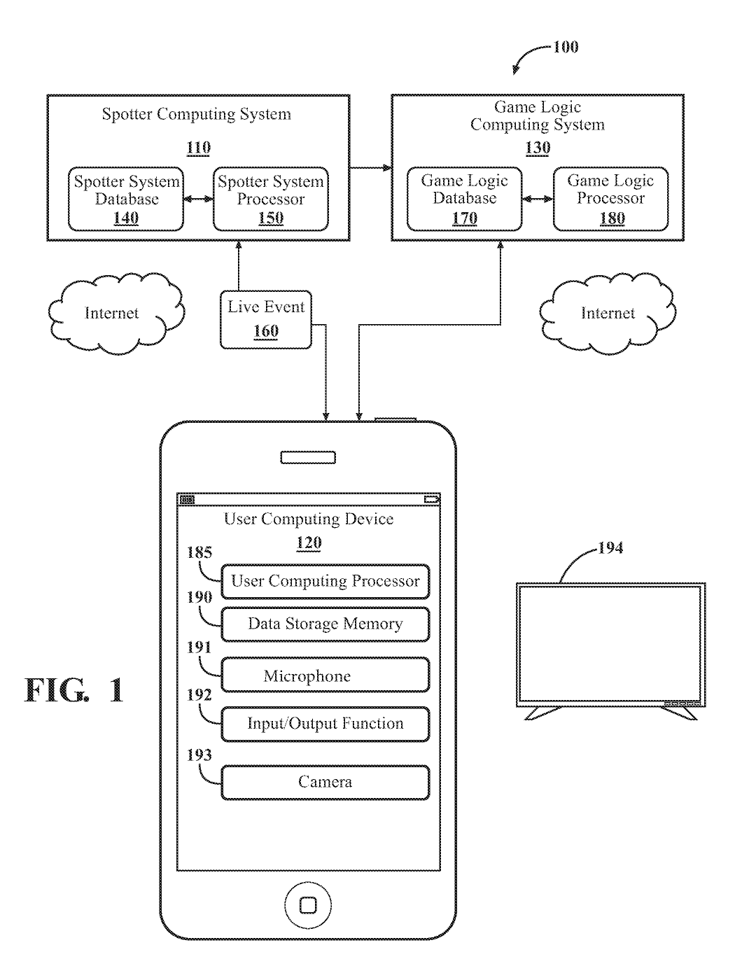

Referring to FIG. 1, FIG. 1 shows a system diagram of an example gaming system 100 for managing predictions of outcomes of a sub-event in real time based on a live event 160. As used herein, a live event refers to an event occurring in real time that has not concluded in its entirety. The live event 160 may be a game, a contest, a sporting event, a tournament, a television series, a match, an election, a show, an award ceremony, or the like. The sub-event is an event that occurs within/during the live event 160, which may be a mini-game, a match, a play, a shot, a player, or the like.

Even though the systems and methods described herein are generally described with respect to a sporting event, such as a football game, these systems and methods are applicable to all live events, regardless of the type of event.

The gaming system 100 may be accessed by a user, such as a web-based user or a mobile application user (collectively, “users”). The gaming system 100 includes a graphical user interface (GUI) that may be displayed by a user through a web browser or a mobile software application. The mobile software application is configured to, among other things, manage and present live event information and allow users to predict outcomes of sub-events occurring during the live event through a user computing device 120.

The live event is broadcast to the user on a secondary device 194 (separate from the user computing device 120) in real time. The secondary device 194 may be a television, a computer, a tablet, a mobile device, a handheld device, or the like.

The gaming system 100 comprises a spotter computing system 110 configured to sort and process live broadcast data from the live event 160 and to convert the broadcast data into a set of sequential events. In some examples, the broadcast data comprise plays from a live sporting event. The spotter computing system 110 is configured to receive the live broadcast data from the live event 160 through a live event feed. The live event feed comprises a stream of timestamped video frames known as a live event video feed. An example of the live event video feed is a television broadcast of an American football game.

In some examples, the live broadcast data may also include structured data describing the events contained in a corresponding live event video feed. A stream of such structured data is known as a live event data feed. An example of the live event data feed is a play-by-play log from an American football game.

The spotter computing system 110 comprises a spotter system database 140 and a spotter system processor 150 in communication with the spotter system database 140. The spotter computing system 110 is configured to receive various event information and data from various live events in real time. The spotter system database 140 is configured to store the data and information corresponding to the sets of sequential events for a particular event broadcast. As such, the spotter computing system 110 creates a “play-by-play” timeline of the live events 160.

The data and information stored on the spotter system database 140 is used for determining which users correctly predicted the outcomes of sub-events in the live event 160. In some examples, the spotter computing system 110 sorts and processes the broadcast data into the set of sequential events without any human intervention. In other examples, the spotter computing system 110 involves a human manually sorting and processing the broadcast data in order to determine the set of sequential events.

The spotter computing system 110 may be used to analyze the broadcast data to determine actions, scores, teams, players, and the like. For example, the spotter computing system 110 may segment the broadcast data and information, such as the player/team involved in each play and the outcome for each play in a football game (e.g. touchdown, long pass, any pass, etc.) or any action/sub-event in the live event 160. As a result, users are provided with an opportunity to predict the outcomes of future sub-events/actions based on the outcomes of prior sub-events/actions that have already occurred during the live event 160.

Users may access the gaming system 100 through the user computing device 120. The user computing device 120 may be any computing device, such as, but not limited to a smartphone, smart watch, tablet, notebook computer, computer server, personal digital assistant, mobile device, handheld device, or any other functionally equivalent device known in the art. The user computing device 120 may operate with various operating systems known in the art, such as but not limited to, Microsoft Windows® or mobile device operating systems, Apple® operating systems, Android® operating systems, and the like. The user computing device 120 is configured to run an application interface that provides users with the ability to access and use the gaming system 100.

In some examples, the user computing device 120 comprises a user computing processor 185, a data storage memory 190, a microphone 191, an input/output function 192, and a camera 193. The processor may include one or more CPUs, such as one or more general purpose processors and/or one or more dedicated processors. The user computing processor 185 is configured to execute memory-storing instructions. The data storage memory 190 may include any volatile, non-volatile, magnetic, or electrical media, such as a random-access memory (RAM), read-only memory (ROM), flash memory, or any other digital media.

The input/output function 192 facilitates user interaction with the user computing device 120. The input/output function 192 may comprise multiple types of input devices, such as a mouse, a keyboard, a touchscreen, and functionally equivalent devices. In some embodiments, users interact with the mobile software application and/or each other through the input/output function 192.

The input/output function 192 may also comprise multiple types of output devices, such as a screen, a monitor, a printer, light emitting diodes, and functionally equivalent devices. The microphone 191 is capable of accepting audio input from the user. The camera 193 is capable of capturing a digital image and/or video. The input devices and the output devices of the input/output function 192 are communicatively coupled to the user computing device 120.

The computing system 100 further comprises a game logic computing system 130 configured to record user predictions and compare them with the live broadcast data. The game logic computing system 130 is configured to record user predictions for the sub-events, to compare the user predictions to the live broadcast data for the live event 160, and to award points to users based on the accuracy of their predictions for the sub-events.

The game logic computing system 130 comprises a game logic database 170 and a game logic processor 180 connected to the game logic database 170. The game logic database 170 is configured to store data associated with the predictions made by users through their respective user computing devices 120 and a latency-adjusted timestamp corresponding to each of the predictions.

In some examples, the game logic computing system 130 is further configured to receive new data from either the spotter computing system 110 or from the user computing device 120 via a wireless connection. The wireless communication may occur over a network, or other forms of indirect communication. Communications may occur directly over a local area network (LAN), wide area network (WAN) such as the Internet, cloud environment, telecommunications network, Wi-Fi, Bluetooth, or any other communications technique. In other examples, the communication between the game logic computing system 130 and the spotter computing system 110 or the game logic computing system 130 and the user computing device 120 may occur via a wired connection.

The game logic computing system 130 is further configured to determine if the user's prediction was made before the sub-event occurred in the live event 160 and whether the user should be awarded any points for the prediction. For example, the game logic computing system 130 analyzes whether a user correctly predicted the outcome of a play in a football game within an allotted period of time set by the spotter computing system 110. In some examples, a timing device on the graphical user interface of the user computing device counts down the number of seconds remaining for the user to make a prediction for the outcome of the next sub-event in the live event 160.

The allotted period of time is meant to ensure that the user enters a prediction with the gaming system 100 prior to the sub-event being displayed on the secondary device 194. The information associated with determining whether a user deserves any points for a prediction is stored in the game logic database 170 for future use for comparing users that are participating in the same live event 160.

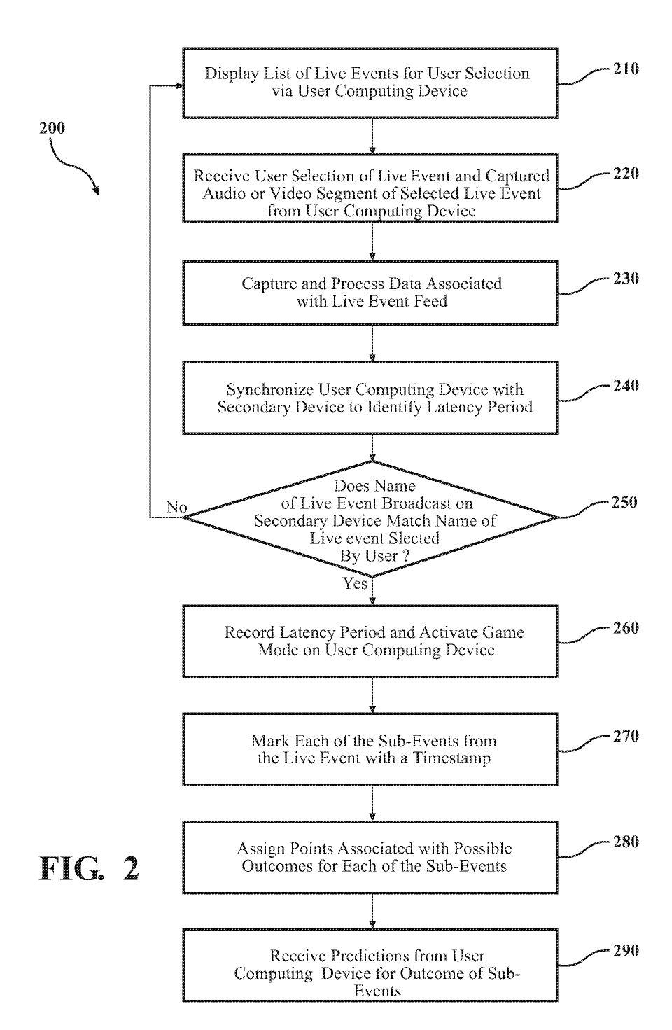

Referring to FIG. 2, FIG. 2 shows a flow chart of an exemplary method 200 for receiving and processing a prediction from a user during the live event 160 using the gaming system 100 of FIG. 1. Once the user registers for and accesses the gaming system 100 on the user computing device 120, the gaming system 100 displays a list of available live events for a user to select from and participate in via the user computing device 120, as shown in block 210. The user may register for and access the gaming system 100 either through a web browser or a mobile software application by providing the necessary authorization information, such as a username and password.

The live event 160 may be a game, a contest, a sporting event, a tournament, a television series, a match, an election, a show, an award ceremony, or the like. In some examples, the list of live events is a list of American football games occurring on a particular day.

The gaming system 100 then receives the user's selection of a live event from the list of live events, along with an audio and/or video segment of the live event 160 that was captured by the user computing device 120, as shown in block 220. In some examples, the user may view the live event 160 on the secondary device 194. In the embodiment shown in FIG. 2, a small video segment of the live event 160 is recorded using the camera 193 of the user computing device 120 by scanning the secondary device 194.

In another embodiment, the user records a small segment of audio from the live event 160 being broadcasted on the secondary device 194 using the microphone 191 on the user computing device 120. In yet another embodiment, the user uses both the camera 193 and the microphone 191 on the user computing device 120 to capture a small segment of video and audio, respectively, from the live event 160 being broadcasted. In some examples, the small segment of the live event 160 comprises less than two seconds of recorded broadcast on the secondary device 194.

As shown at block 230, the spotter computing system 110 captures and process data associated with a live event feed from the broadcast live event 160. The live event feed has content associated with a plurality of sub-events from the broadcast live event 160. The content from the live event feed is captured by the spotter computing system 110 prior to the sub-events being displayed on the secondary device 194. The live event feed further comprises a plurality of timestamped video frames displaying the content associated with the sub-events and a data feed describing the sub-events in the timestamped video frames.

In some examples, the sub-events may be displayed on the secondary device 194 prior to the spotter computing system 110 capturing the live event feed.

In the exemplary embodiment shown in FIG. 2, the live event 160 is a television broadcast of an American football game and the sub-events are the plays occurring in sequential order in the game. The spotter computing system 110 will receive video footage of the plays in sequential order, along with descriptions of the plays, such as the type of play (pass, rush, etc.), the result of the play (touchdown, field goal, sack, safety, etc.), and the team/player that made the play. Other embodiments may not include a live event feed as it may not be available for a particular live event.

Next, as shown in block 240, the gaming system 100 synchronizes the user computing device 120 with the secondary device 194 based on the information corresponding to the broadcast live event 160 and the live event feed in order to identify a latency period between the secondary device 194 and the live event feed. The gaming system 100 identifies the latency period by analyzing the small segment of the broadcasted live event 160 that the user computing device 120 scanned.

Next, as shown in block 250, the gaming system 100 determines whether the name of the live event 160 being broadcast on the secondary device 193 matches the name of the live event 160 selected by the user. If it does, then the latency period will be recorded in the game logic computing system 130 and the user computing device 120, at which point the user computing device 120 is sent into “game mode” on the gaming system 100, as shown in block 260. If the live event 160 being broadcasted does not match the name of the live event selected by the user, the user will not be able to fully participate in the gaming system 100.

In some embodiments, the data from the live event feed is processed into a new set of structured data in the spotter computing system 110 for later use on the gaming system 100. The processing of live event data into a new set of structure data by the spotter computing system 110 may be performed by either a human operating a counsel or by a computer processor deciphering the respective data feeds. At this point, every sub-event, such as the start of a play on the field, the announcement of a winner, etc., which occurs during the live event 160 is marked with a timestamp in the corresponding live event feed, as shown in block 270. The spotter computing system 110 receives the live broadcast data from the live event 160 on the user computing device 120 prior to the broadcasting of the live event 160 on the secondary device 194.

The operator of the spotter computing system 110 (human or computer processor) records a timestamp for the start of the sub-event occurring during a live event and assigns points to the various possible outcomes of the sub-event to be selected by the user, as shown in block 280. For example, in an American football game, each play has a timestamp corresponding with the start of the play on the field, such as when the quarterback “hikes” the ball, and points may be awarded to the user for a variety of different possible selections based on the outcome of this play and subsequent plays.

In some examples, the number of points vary depending on the outcomes of sub-events occurring during the live event 160. The amount of points may be directly associated with the net positive effect of a particular play/event. For example, if the user correctly predicted that the previous play was a “pass,” the amount of points that the user is rewarded is directly based on the number of yards corresponding to the “pass.” Since a pass play for more yards is worth more points than a pass play for fewer yards, the user may be awarded with a different amount of points for each correct prediction.

In some examples, the amount of points to be awarded for correctly predicting the outcome of each of the sub-events will be displayed on the graphical user interface of the user computing device 120 when making predictions. In some examples, the point total associated with the various outcomes of the sub-events are dynamically adjusted based on the outcomes of previous plays/sub-events.

After the timestamp and scoring data are determined for the possible outcomes of sub-events in the live event 160, the timestamp and scoring data are recorded in the spotter system database 140 that stores all the sequential events for the broadcast. The timestamp and scoring data will be used later to determine which users made correct predictions for the outcomes of the sub-events.

As shown in block 290, the spotter computing system 110 then receives, from the user computing device 120, at least one prediction for the outcome of at least one of the sub-events associated with the broadcast live event 160. The predictions from the user computing device 120 are received by the spotter computing system 110 before the sub-event is actually displayed for the user on the secondary device 194.

In the “game mode” of the gaming system 100, the user continuously predicts the outcomes of subsequent sub-events using the user computing device 120 while watching the live event 160 on television. For example, while watching an American football game, the user may predict whether the next sub-event (or play) will be a pass, a run, or something beneficial for the defense. The user may also predict whether the next play will specifically be a long pass, a long rush, a short pass, a short rush, etc.

In addition to predicting the type of play that will result in a net positive effect, the user can also predict the result of the selected play. Examples of results that the user may select when the live event 160 is a football game include offensive touchdown, defensive touchdown, turnover, sack, 1^{st} down, safety, etc.

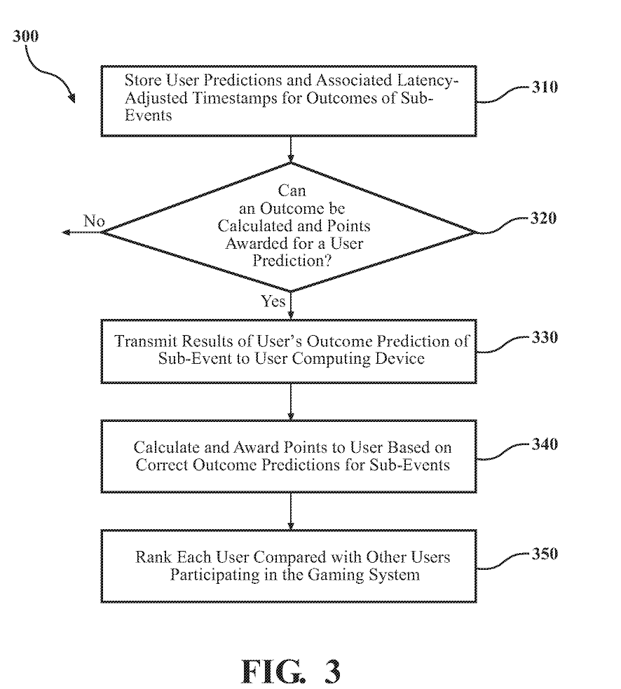

Referring to FIG. 3, FIG. 3 shows a flow chart of an exemplary method 300 for awarding points to a user based on the accuracy and timeliness of the user's predictions during the live event 160 using the gaming system 100 of FIG. 1. As shown at block 310, the game logic database 170 stores each prediction made by the user on the user computing device 120 for the outcome of a sub-event. The game logic database 170 also stores the latency-adjusted timestamp associated with each prediction. The game logic database 170 stores information pertaining to whether or not the user deserves any points for the prediction of an outcome of a specific sub-event. This information is stored for future use in calculating total points and ranking users that are participating in the same live event.

In addition to the latency-adjusted timestamp associated with each prediction, there may be additional delays between the user making a prediction and the prediction being transmitted to and received by the spotter computing system 110. In some examples, the spotter computing system 110 may receive the user prediction in less than one second, such as in a few hundred milliseconds. The delay may be due to connectivity issues with the network.

As shown at block 320, the game logic computing system 130 determines whether or not an outcome may be calculated and points may be awarded each time that it receives new data from either the spotter computing system 110 or the user computing device 120. For example, if there is a user prediction stored, and the sub-event that corresponds to that prediction occurs and is made available from the game logic database 170, the game logic computing system 130 will check to see if the user's prediction was made before the sub-event occurred in the live event 160 and if the user's prediction should be awarded any points.

After the game logic computing system 130 has compared a user prediction to the data corresponding to the live sub-event, the game logic computing system 130 notifies the user computing device 120 of the results of the user's prediction for the sub-event, as shown at block 330. In some examples, the results are displayed briefly on the user computing device 120 and then the user computing device 120 will reset allowing the user to timely make the next prediction for a new sub-event.

As shown at block 340, the game logic computing system 130 calculates and awards points to users based on correctly predicting outcomes of sub-events occurring during the live event 160. In some examples, the game logic computing system 130 may also rank each user participating in the gaming system 100 during the live event 160, as shown in block 350. Each user may view his/her ranking as compared with other users for the live event 160 through each user computing device 120. In some embodiments, the ranking may be viewed during the course of the live event 160. In other embodiments, the ranking may only be viewed upon the termination of the live event 160.

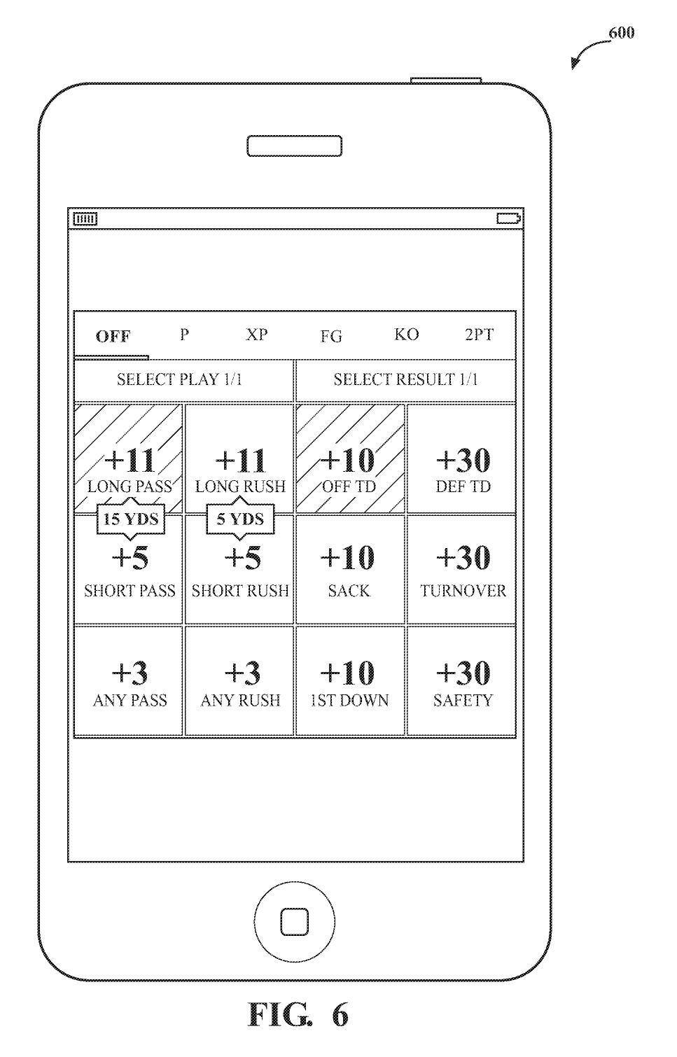

In examples where the live event 160 is a football game, more conservative predictions, such as “ANY PASS” or “ANY RUSH,” will render fewer possible points, as compared with predictions, such as “LONG PASS+1^{ST} DOWN,” where the user may receive points for correctly predicting the type of play to occur, along with the specific result of the selected play, as shown FIG. 6. Despite the potential reward of receiving more points for correctly predicting the type of play and the result of the play, there is more of a risk to the user in choosing both a play and a result for that play since the user may receive no points if any part of the prediction is incorrect.

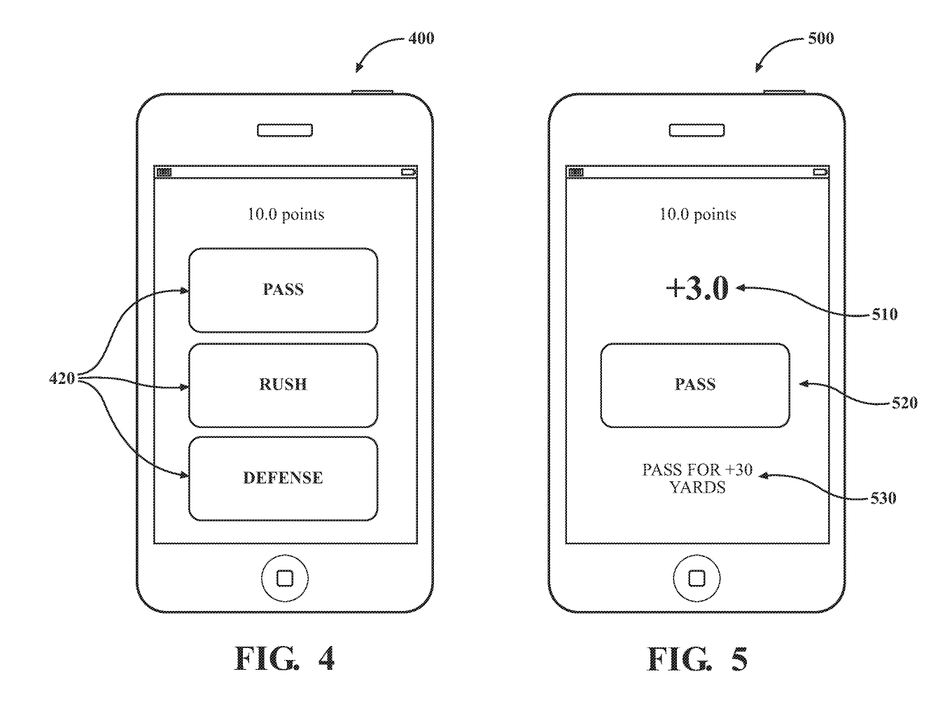

Referring to FIG. 4, FIG. 4 shows a graphical user interface drawing of an example GUI 400 on the user computing device 120 for predicting the outcome of a sub-event through the gaming system 100 of FIG. 1. The graphical user interface 400 displays the total points awarded to the user for a specific time period during the live event 160 (e.g. 10 points) and selections 420 of sub-events (e.g. plays in a football game) from which the user predicts the outcome of the next sub-event to occur during the live event 160 prior to the next sub-event actually occurring during the live event 160 being broadcasted on the secondary device 194.

In this exemplary graphical user interface 400, there are three selections 420 for the user to choose from. In some examples, the selections 420 correspond to plays in a live American football game, such as “RUSH,” “PASS,” and “DEFENSE.” In the example of FIG. 4, the user makes a single selection from the selections 420 on the user computing device 120 based on which play, having a positive effect, the user believes will occur next during the live event 160 being broadcasted. For example, if the user believes that there will be a net loss of yards for the offense on the next play, the user selects the selection 420 corresponding to “DEFENSE.”

The graphical user interface 400 of FIG. 4 is an example of a graphical user interface where the live event 160 being viewed by the user is American football. However, other user interface layouts may be used and the graphical user interface 400 shown in FIG. 4 is just one possible example. The graphical user interface 400 may be a web-based user interface or part of a mobile software application that operates on the user computing device 120.

Referring to FIG. 5, FIG. shows graphical user interface drawing of an example GUI 500 on the user computing device 120 for displaying the outcome of the user's prediction through the gaming system of FIG. 1. The graphical user interface 500 of FIG. 5 displays the total points awarded to the user in the upper portion of the graphical user interface 500, followed by the net number of points awarded to the user corresponding to the user's most recent selection 510, followed by the user's previously selected prediction 520, and followed by a brief description of the outcome of the previous sub-event (e.g. play) 530 that occurred in the live event 160.

In FIG. 5, the total points awarded to the user is now 13 points, instead of 10 points, since the user was rewarded with additional points for correctly predicting the outcome of the previous sub-event (e.g. play) during the live event 160. Also, as shown in FIG. 5, net number of points awarded to the user corresponding to the user's most recent selection 510 is +3.0, the user's selected prediction 520 is pass, and the description of the outcome of the last sub-event 530 is “PASS FOR +30 YARDS.” In this example, the last sub-event resulted in a passing play for 30 yards.

The graphical user interface 500 is an example of a graphical user interface for American football. However, other user interface layouts may be used and the graphical user interface 500 shown in FIG. 5 is just one possible example. The graphical user interface 500 may be a web-based user interface or part of a mobile software application that operates on the user computing device 120.

Referring to FIG. 6, FIG. 6 shows an example GUI 600 for making predictions on the user computing device 120 for the type of play and result of the play through the gaming system 100 of FIG. 1. In this example, the GUI 600 displays six different sub-events (plays) to select from with regard to the type of play and six different possible results of the selected sub-events (plays) to select from, wherein the plays are all offensive plays for a particular American football team. In this example, the user has selected the “LONG PASS” option (worth a possible 11 points) for the play/sub-event and the “OFF TD” option (worth a possible 10 points) as the selected result for the play/sub-event. In other words, the user is predicting that the next play in the game will be a pass of more than 15 yards, which will result in an offensive touchdown.

The live event 160 disclosed herein may be broadcasted through a television or on the Internet for a user to view while participating in the gaming system 100. Alternatively, the user may attend and view the live event 160 in person, while participating in the gaming system 100.

As used herein, computing system and computer readable storage media do not cover signals or other such unpatentable subject matter. Only non-transitory computer readable storage media is intended within the scope and spirit of claimed subject matter.

It will, of course, be understood that, although particular examples have just been described, the claimed subject matter is not limited in scope to a particular example or limitation. Likewise, an example may be implemented in any combination of compositions of matter, apparatuses, methods or products made by a process, for example.

In the preceding description, various aspects of claimed subject matter have been described. For purposes of explanation, specific numbers, percentages, components, ingredients and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features and examples have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A computer-implemented method for managing predictions of outcomes in live events, the method comprising:
generating a list of live events for display on a graphical user interface of a user computing device;
receiving a selection of a live event from the list of live events, the selection of the live event is associated with a user;
receiving a captured audio and/or video segment of the live event from the user computing device, the live event is broadcast to the user on a secondary device in real time;
capturing and processing, via a computing system, data associated with a live event feed, the live event feed has content associated with a plurality of sub-events from the broadcast live event, the live event feed further comprises:
a plurality of timestamped video frames displaying the content associated with the sub-events; and
a data feed, the data feed describes the sub-events in the timestamped video frames;
synchronizing the user computing device with the secondary device based on information corresponding to the broadcast live event and the live event feed to identify a latency period between the secondary device and the live event feed;
marking, via the computing system, each of the sub-events from the live event feed with a timestamp at the start of each of the sub-events,
assigning points, via the computing system, associated with a plurality of possible outcomes for each of the sub-events;
storing, on a database of the computing system, data associated with the sequential sub-events for the broadcast live event including the timestamp for each of the sub-events and the points assigned for the possible outcomes for each of the sub-events;
receiving, via the computing system, at least one prediction from the user computing device for the outcome of at least one of the sub-events associated with the broadcast live event, the at least one prediction is received by the computing system prior to the sub-events being displayed on the secondary device; and
determining whether an outcome may be calculated and points may be awarded from the at least one prediction based on the data associated with the sub-event and the time in which the computing system received the at least one prediction.

2. The computer-implemented method of claim 1, the live event is a game, a contest, a sporting event, a tournament, a television series, a match, an election, a show, or an award ceremony.

3. The computer-implemented method of claim 1, the secondary device is a television, a computer, a tablet, a mobile device, or a handheld device.

4. The computer-implemented method of claim 1, the captured audio and/or video segment of the live event is less than two seconds in duration.

5. The computer-implemented method of claim 1, the content from the live event feed is captured by the computing system prior to the sub-events being displayed on the secondary device.

6. The computer-implemented method of claim 1, further comprising dynamically displaying on the graphical user interface of the user computing device a timing device notifying the user of the amount of time remaining for the computing system to receive one of the at least one predictions for the outcome of the next sub-event in the live event.

7. The computer-implemented method of claim 1, further comprising dynamically calculating and awarding points to the user during the live event based upon a determination that the prediction from the user computing device was received by the computing system before the sub-event was displayed on the secondary device.

8. The computer-implemented method of claim 7, further comprising dynamically ranking the user compared to other users of the computing system based on total amount of points awarded during the live event.

9. The computer-implemented method of claim 1, further comprising storing on the computing system a latency-adjusted timestamp associated with each of the at least one predictions received from the user computing device.

10. A system for managing predictions of outcomes in live events, the system comprising:
a user application configured to be distributed to one or more user computing devices, the user application configured to receive one or more selections of live events and one or more predictions for outcomes of sub-events from the user computing device, the live event is broadcast to the users on a secondary device in real time;
a spotter computing system, the spotter computing system having a spotter system database configured to store data and information corresponding to sequential sub-events occurring during the live event;
the spotter computing system further comprising a spotter system processor in communication with the spotter system database, the spotter system processor configured to capture and process the data and information corresponding to sequential sub-events occurring during the live event;
the spotter computing system further configured to:
synchronize the user computing device with the secondary device based on the sequential sub-events occurring during the live event;
identify a latency period between the secondary device and a live event feed obtained from the live event; and
mark each of the sub-events from the live event with at least one latency-adjusted timestamp;
a game logic computing system, the game logic computing system having a game logic database configured to store data and information corresponding to the predictions made by users for outcomes of sub-events associated with the live event and the latency-adjusted timestamps associated with the predictions;
the game logic computing system further comprising a game logic processor in communication with the game logic database, the game logic processor configured to process the data and information corresponding to predictions made by users for outcomes of sub-events associated with the live event and the latency-adjusted timestamps associated with the predictions; and
the game logic computing system further configured to:
assign points associated with the plurality of possible outcomes for each of the sub-events;
determine outcomes for the predictions based on the data associated with the sub-event and the latency-adjusted timestamps associated with the predictions; and
dynamically award points to the user during the live event based upon determining that the predictions from the user computing device were received by the game logic computing system before the sub-event occurred in the live event and before the sub-event was displayed on the secondary device.

11. The system of claim 10, the live event is a game, a contest, a sporting event, a tournament, a television series, a match, an election, a show, or an award ceremony.

12. The system of claim 10, the secondary device is a television, a computer, a tablet, a mobile device, or a handheld device.

13. The system of claim 10, the spotter computing system further configured to receive a captured audio and/or video segment of the live event from the user computing device.

14. The system of claim 13, the audio and/or video segment of the live event is less than two seconds in duration.

15. The system of claim 10, the points are assigned based on an estimated probability of outcomes occurring for each of the sub-events.

16. The system of claim 10, the live event feed comprises a plurality of timestamped video frames displaying content associated with the sub-events and a data feed describing the sub-events in the timestamped video frames.
